(19) United States
(12) Patent Application Publication
(10) Pub. No.: US 2026/0245342 A1
(43) Pub. Date: Aug. 20, 2026

(54) PSEUDO-LABEL GENERATION DEVICE AND A METHOD THEREOF

(71) Applicants: HYUNDAI MOTOR COMPANY, Seoul (KR); KIA CORPORATION, Seoul (KR)

(72) Inventors: Jae Ha Lee, Hwaseong-si (KR); Young Hyun Kim, Hwaseong-si (KR)

(73) Assignees: HYUNDAI MOTOR COMPANY, Seoul (KR); KIA CORPORATION, Seoul (KR)

(21) Appl. No.: 19/385,753

(22) Filed: Nov. 11, 2025

(30) Foreign Application Priority Data
Feb. 14, 2025 (KR) 10-2025-0019174

(51) Int. Cl. G06V 10/764; G01S 17/89; G06V 10/82; G06V 20/70

(52) U.S. Cl. CPC G06V 10/764; G01S 17/89; G06V 10/82; G06V 20/70

(57) ABSTRACT

A pseudo-label generation device includes a camera that acquires an image, a LiDAR sensor that acquires points including three-dimensional information and a processor that performs labeling based on the image and the points. The processor may generate 2D bounding boxes for classifying objects by performing deep learning on the image, project the points onto the image, and cluster the points based on depth values of the points to generate 3D bounding boxes.

### CROSS-REFERENCE TO RELATED APPLICATION

This application claims the benefit of priority to Korean Patent Application No. 10-2025-0019174, filed in the Korean Intellectual Property Office on Feb. 14, 2025, the entire contents of which are incorporated herein by reference.

### TECHNICAL FIELD

The present disclosure relates to a pseudo-label generation device and a method thereof, and more specifically to a technique for labeling three-dimensional points.

### BACKGROUND

An autonomous vehicle refers to a vehicle capable of driving itself without operation of a driver or a passenger. An automated vehicle & highway system refers to a system that performs monitoring and control such that the autonomous vehicle is able to drive itself. In addition, technologies are being proposed to monitor the exterior environment of the vehicle and operate various driving assistance means based on the monitored exterior environment to assist the driver in driving.

An autonomous vehicle or a vehicle equipped with driving assistance devices may monitor the outside (e.g., environment) of the vehicle to detect an object or objects and control the vehicle based on a scenario determined according to the detected object. To determine the external environment of the vehicle in real time, it is common for autonomous vehicles to acquire data about the external environment using cameras or LiDAR (e.g., LiDAR sensors), and to learn the data using an object classification network.

To improve the object classification performance of the object classification network, it is beneficial (e.g., for the network) to learn more training data. The training data for object classification networks to learn based on supervised learning is labeled data, also known as ground truth (GT). The labeling process requires a significant amount of time and manpower as it is performed manually to ensure accuracy.

In particular, to improve object classification performance, fusion technology is used to fuse two-dimensional images acquired by cameras and three-dimensional points acquired by LiDAR (e.g., LiDAR sensors), and the labeling data for sensor fusion technology requires ground truth data that fuses two-dimensional images and three-dimensional points. When objects are close together or when objects overlap each other, the three-dimensional points projected on the image are often located such that it is not easy for the operator to determine which object the three-dimensional points correspond to. As a result, labeling data for sensor fusion techniques is time-consuming and expensive.

### SUMMARY

The present disclosure has been made to solve the above-mentioned problems occurring in the prior art while maintaining advantages achieved by the prior art intact.

An aspect of the present disclosure provides a pseudo-label generation device and a method thereof, which accelerate a labeling process for training an object classification network.

An aspect of the present disclosure provides a pseudo-label generation device and a method thereof, which reduce errors that may occur in the labeling process for training an object classification network.

The technical problems to be solved by the present disclosure are not limited to the aforementioned problems, and any other technical problems solved by the present disclosure not mentioned herein should be clearly understood from the following description by those of ordinary skill in the art to which the present disclosure pertains.

According to an aspect of the present disclosure, a pseudo-label generation device includes a camera that acquires an image, a LiDAR sensor that acquires points including three-dimensional information, and a processor that performs labeling based on the image and the points. The processor may generate two-dimensional (2D) bounding boxes for classifying objects by performing deep learning on the image, project the points onto the image, and cluster the points based on depth values of the points to generate three-dimensional (3D) bounding boxes.

In an embodiment, the processor may determine a size of each of the 2D bounding boxes, and remove a 2D bounding box whose size is less than a threshold size from among the 2D bounding boxes.

In an embodiment, the processor may determine a confidence score of each of the 2D bounding boxes, and remove a 2D bounding box whose confidence score is less than a threshold value from among the 2D bounding boxes.

In an embodiment, the processor may project a ray of the camera onto the image, and cluster 3D points matched to the ray.

In an embodiment, the processor may set the ray to pass through the 2D bounding boxes.

In an embodiment, the processor may cluster the 3D points matched to the ray based on a Gaussian mixture model generated by setting a number of the 2D bounding boxes as a number of clusters.

In an embodiment, the processor may identify a class of the 2D bounding box, determine a standard size of an object corresponding to the class, and determine an initial value for a variance of the Gaussian mixture model based on the standard size.

In an embodiment, the Gaussian mixture model may determine a mixture coefficient, a mean, and a covariance using an expectation-maximization algorithm.

In an embodiment, the processor may determine a number of the points included within the 3D bounding box while moving a position of the 3D bounding box within a predetermined range, and determine a position with a largest number of the points as a final position of the 3D bounding box.

In an embodiment, the processor may extract class information, coordinate information, and heading information of the object, which correspond to each of the 2D bounding boxes, by performing deep learning on the image, and match the class information, the coordinate information, and the heading information of the object to the 3D bounding box.

According to an aspect of the present disclosure, a pseudo-label generation method includes: generating, by a processor, two-dimensional (2D) bounding boxes for classifying objects by performing deep learning on an image acquired by a camera; projecting, by the processor, points acquired by a LiDAR sensor onto the image; and clustering, by the processor, the points based on depth values of the points to generate three-dimensional (3D) bounding boxes.

In an embodiment, the generating of the 2D bounding boxes may include determining a size of each of the 2D bounding boxes, and removing a 2D bounding box whose size is less than a threshold size from among the 2D bounding boxes.

In an embodiment, the generating of the 2D bounding boxes may include determining a confidence score of each of the 2D bounding boxes, and removing a 2D bounding box whose confidence score is less than a threshold value from among the 2D bounding boxes.

In an embodiment, the clustering of the points to generate the 3D bounding boxes may include projecting a ray of the camera onto the image, and clustering 3D points matched to the ray.

In an embodiment, the projecting of the ray of the camera onto the image may include setting the ray to pass through the 2D bounding boxes.

In an embodiment, the clustering of the points to generate the 3D bounding boxes may include clustering the 3D points matched to the ray based on a Gaussian mixture model generated by setting a number of the 2D bounding boxes as a number of clusters.

In an embodiment, the clustering of the points to generate the 3D bounding boxes may include identifying a class of the 2D bounding box, determining a standard size of an object corresponding to the class, and determining an initial value for a variance of the Gaussian mixture model based on the standard size.

In an embodiment, the Gaussian mixture model may determine a mixture coefficient, a mean, and a covariance using an expectation-maximization algorithm.

In an embodiment, the pseudo-label generation method may further include determining a number of the points included within the 3D bounding box while moving a position of the 3D bounding box within a predetermined range, and determining a position with a largest number of the points as a final position of the 3D bounding box.

In an embodiment, the pseudo-label generation method may further include extracting class information, coordinate information, and heading information of the object, which correspond to each of the 2D bounding boxes, by performing deep learning on the image, and matching the class information, the coordinate information, and the heading information of the object to the 3D bounding box.

### BRIEF DESCRIPTION OF THE DRAWINGS

The above and other objects, features and advantages of the present disclosure should be more apparent from the following detailed description taken in conjunction with the accompanying drawings:

FIG. 1 is a diagram illustrating a vehicle equipped with a pseudo-label generation device according to an embodiment of the present disclosure;

FIG. 2 is a block diagram illustrating a configuration of a pseudo-label generation device according to an embodiment of the present disclosure;

FIG. 3 is a flowchart for describing a label generation method according to an embodiment of the present disclosure.

FIG. 4 is a diagram showing 2D bounding boxes according to an embodiment of the present disclosure.

FIG. 5 is a diagram for describing coordinate systems.

FIG. 6 is a diagram for describing a camera ray;

FIG. 7 is a diagram for describing a method of setting up a camera ray;

FIG. 8 is a diagram for describing clustering of points matched to a camera ray;

FIG. 9 is a diagram illustrating an embodiment in which 3D bounding boxes are generated;

FIG. 10 is a diagram for describing additional information being matched to 3D bounding boxes;

FIG. 11 is a flowchart for describing a method for filtering 2D bounding boxes output by an object classification network; and

FIG. 12 is a diagram illustrating a computing system according to an embodiment of the present disclosure.

### DETAILED DESCRIPTION

Hereinafter, some embodiments of the present disclosure are described in detail with reference to the drawings. In adding the reference numerals to the components of each drawing, it should be noted that the identical or equivalent components are designated by identical numerals even when they are displayed on other drawings. Further, in describing the embodiments of the present disclosure, a detailed description of well-known features or functions has been omitted in order to avoid unnecessarily obscuring the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those having ordinary skill in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application. When a component, unit, controller, device, element, apparatus or the like of the present disclosure is described as having a purpose or performing an operation, function, or the like, the component, unit, controller, device, element, or apparatus should be considered herein as being “configured to” meet that purpose or perform that operation or function. Each component, unit, controller, device, element, apparatus, and the like may separately embody or be included with a processor and a memory, such as a non-transitory computer readable media, as part of the apparatus.

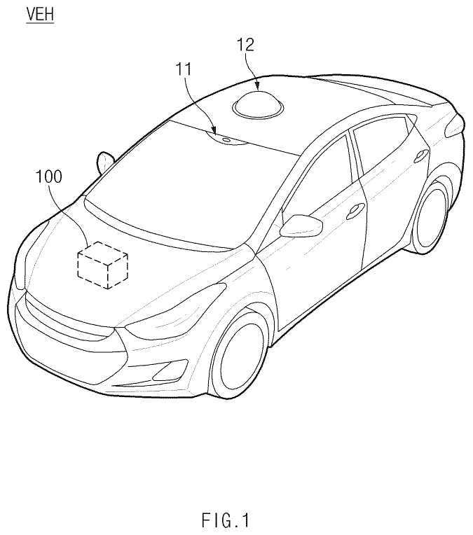

Hereinafter, embodiments of the present disclosure are described in detail with reference to FIGS. 1-12.

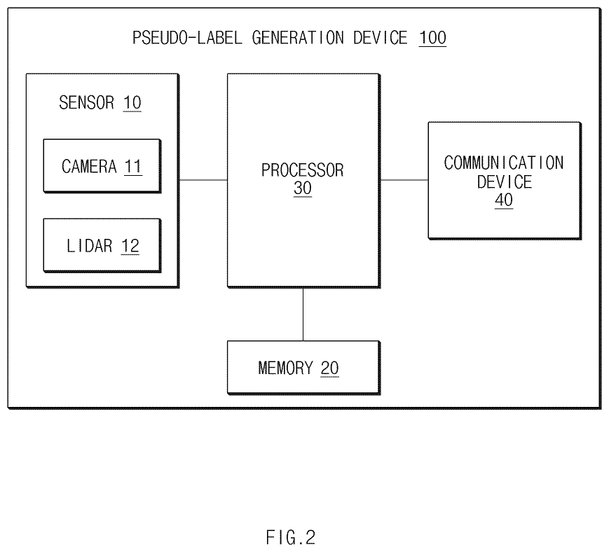

FIG. 1 is a diagram illustrating a vehicle equipped with a pseudo-label generation device according to an embodiment of the present disclosure. FIG. 2 is a block diagram illustrating a configuration of a pseudo-label generation device according to an embodiment of the present disclosure.

Referring to FIGS. 1 and 2, a pseudo-label generation device according to an embodiment of the present disclosure may include a sensor 10, a memory 20, and a processor 30.

The sensor 10 may be for detecting an object in the vicinity of a vehicle, and may include a camera 11 and a (Light Detection and Ranging) LiDAR sensor 12 (also referred to herein as simply LiDAR 12).

The camera 11 may be for acquiring a two-dimensional image, i.e., a 2D image. In the embodiments described herein, the 2D image may be referred to as an image. The camera 11 may be disposed on an upper portion of the front windshield of a vehicle VEH to acquire an image of the area in front of the vehicle VEH. In addition, the camera 11 may be positioned at various positions on the vehicle VEH to capture images of the side-rear or rear areas of the vehicle VEH.

The LiDAR sensor 12 may be for acquiring three-dimensional information of an object and may include a transmitter that emits a laser and a receiver that receives reflected waves that are reflected by the object. The LiDAR sensor 12 may output points including three-dimensional information (e.g., three-dimensional position information) of a specified point of the object based on the reflected waves. A plurality of points (e.g., output by the LiDAR sensor 12 may form a point cloud.

The image acquired by the camera 11 and the points acquired by the LiDAR sensor 12 may be subject to sensor fusion. Accordingly, the camera 11 and the LiDAR sensor 12 may be temporally synchronized and spatially synchronized. For example, the timing of the LiDAR sensor 12 sensing the field-of-view direction of the camera 11 may be synchronized with the shooting timing of the camera 11. Furthermore, the external parameters of the camera 11 and the LiDAR sensor 12 may be pre-stored in the memory 20 or a similar storage medium and subjected to calibration.

The sensor 10 may further include a Radio Detection and Ranging (RADAR) sensor, an ultrasonic sensor, and an infrared sensor to detect an object or objects around the vehicle.

The memory 20 may store algorithms for the operation of the processor 30 and an Artificial Intelligence (AI) processor. The memory 20 may be implemented using a hard disk drive, a flash memory, an electrically erasable programmable read-only memory (EEPROM), a static RAM (SRAM), a ferro-electric RAM (FRAM), a phase-change RAM (PRAM), a magnetic RAM (MRAM), a Dynamic Random Access Memory (DRAM), a Synchronous Dynamic Random Access Memory (SDRAM), a Double Data Rate-SDRAM (DDR-SDRAM), and the like.

The memory 20 may also store video data acquired by the camera 11 and point clouds acquired by the LiDAR sensor 12.

The processor 30 may be for the LiDAR sensor 12 to perform pseudo-labeling by grouping the points.

Pseudo-labeling may refer to labeling operations performed by the processor 30, and may be a term to distinguish it from human-performed labeling. Human-performed labeling may be referred to as ground truth (GT) data that is highly accurate. The pseudo-labeling generated by the processor 30 may be performed primarily to assist the human labeling task.

However, the results of the pseudo-labeling performed by the processor 30 may not be clearly distinguishable from the results of the human-performed labeling. It is assumed that human-performed labeling may be more reliable than pseudo-labeling, and in practice, the results by pseudo-labeling performed by the processor 30 and the results by human-performed labeling may be in the same format. The pseudo-labeling process performed by the processor 30 may also be interpreted as a labeling process. Thus, in the following embodiments, the operation of performing labeling in the processor 30 may also be interpreted as the operation of performing pseudo-labeling.

The processor 30 may perform labeling by fusing an image acquired by the camera 11 and points acquired by the LiDAR sensor 12. To this end, the processor 30 may perform deep-learning on the image based on an object classification network to classify the objects and generate 2D bounding boxes for the classified objects. The processor 30 may also project the points acquired by the LiDAR sensor 12 onto the image. Further, the processor 30 may cluster the points based on the depth values of the 2D bounding boxes to generate a three-dimensional bounding box, i.e., a 3D bounding box. The 3D bounding box may be referred to as a Cuboid, and each Cuboid may be matched with object information. The object information may include class information, position information, and heading direction information.

An object classification network may be implemented with an artificial intelligence (AI) processor and stored in memory 20. The AI processor may learn a neural network using a pre-stored program. The neural network may be designed to computationally simulate the structure of a human brain and may include a plurality of network nodes with weights, which simulate neurons in a human neural network. The plurality of network nodes may transmit and receive data according to their connection relationships so as to simulate synaptic activity of neurons that transmit and receive signals through synapses. The neural network may include a deep learning model developed from a neural network model. In the deep learning model, a plurality of network nodes may exchange data according to convolution connection relationships while being located in different layers. Examples of neural network models may include various deep learning techniques such as Deep Neural Networks (DNN), Convolutional Neural Networks (CNN), Recurrent Neural Networks (RNN), Restricted Boltzmann Machines (RBM), Deep Belief Networks (DBN), and Deep Q-Networks (DQN).

A communication device 40 may be used to transmit the labeling data generated by the processor 30 to the exterior of the vehicle VEH and may include wired or wireless communication protocols.

The communication device 40 may support short-range communication by using at least one of Bluetooth™, Radio Frequency Identification (RFID), Infrared Data Association (IrDA), Ultra Wideband (UWB), ZigBee, Near Field Communication (NFC), Wireless-Fidelity (Wi-Fi), Wi-Fi Direct, and Wireless Universal Serial Bus (USB) technologies.

The communication device 40 may also include a V2X communication module. The V2X communication module may include RF circuitry for wireless communication protocols with a server (Vehicle to Infra (V2I)), another vehicle (Vehicle to Vehicle (V2V)), or a pedestrian (Vehicle to Pedestrian (V2P)).

The communication device 40 may transmit and receive radio signals with at least one of a base station, an external terminal, and a center on a mobile communication network established in accordance with technical standards or communication methods for mobile communications. For example, the communication device 40 may perform communication based on Global System for Mobile communication (GSM), Code Division Multi Access (CDMA), Code Division Multi Access 2000 (CDMA 2000), Enhanced Voice-Data Optimized or Enhanced Voice-Data Only (EV-DO), Wideband CDMA (WCDMA), High Speed Downlink Packet Access (HSDPA), High Speed Uplink Packet Access (HSUPA), Long Term Evolution (LTE), or LTE-A (Long Term Evolution-Advanced).

Alternatively, the communication device 40 may include a communication protocol for transmitting data to an external storage device.

According to another embodiment of the present disclosure, the processor 30 shown in FIG. 2 may be located outside the vehicle VEH. For example, an embodiment of the present disclosure may be implemented as, for example, a system, terminal, or server for performing pseudo-labeling based on data collected from the camera 11 and LiDAR sensor 12.

Additionally, although FIG. 1 illustrates an embodiment in which the camera 11 and the LiDAR sensor 12 are mounted on the vehicle, their installation is not limited to this configuration.

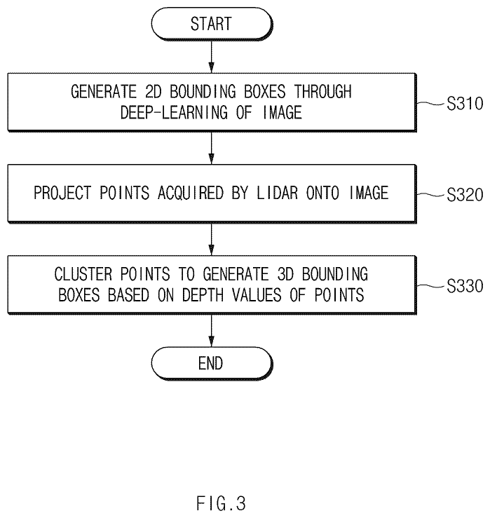

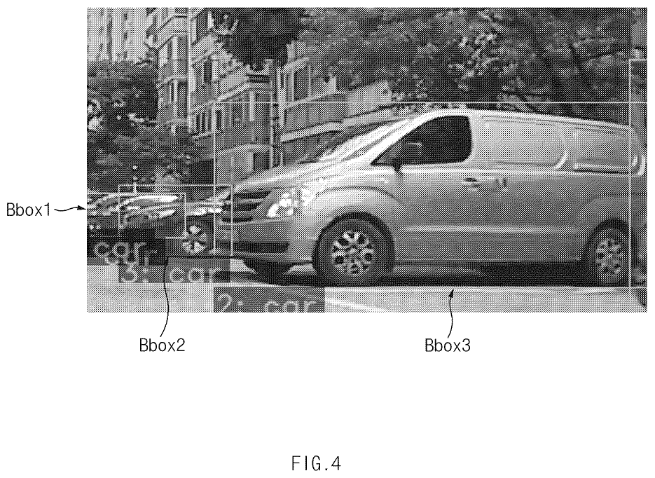

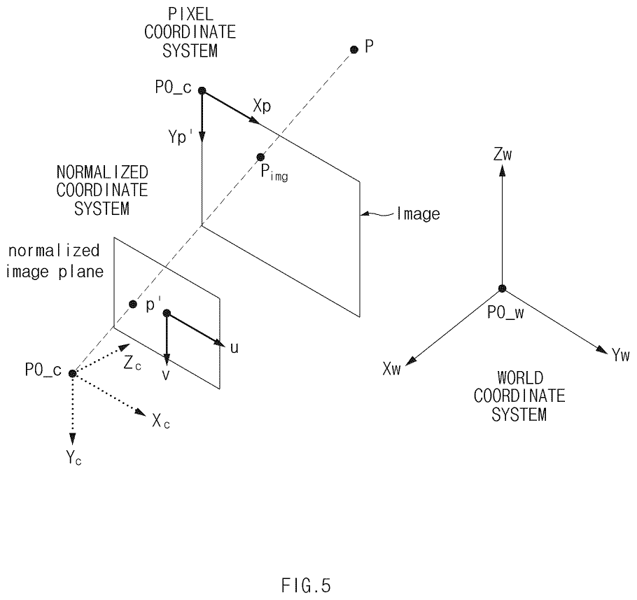

FIG. 3 is a flowchart illustrating a label generation method according to an embodiment of the present disclosure. FIG. 4 is a diagram showing 2D bounding boxes according to an embodiment of the present disclosure. FIG. 5 is a diagram for describing coordinate systems. FIG. 3 may represent a pseudo-label generation process performed by a processor.

A pseudo-label generation method according to an embodiment of the present disclosure is described with reference to FIGS. 3-5.

In S310, the processor 30 may output 2D bounding boxes from a 2D image acquired by the camera 11.

As shown in FIG. 4, the processor 30 may output 2D bounding boxes Bbox1, Bbox2, and Bbox3 from the 2D image and match class information to the 2D bounding boxes Bbox1, Bbox2, and Bbox3.

In step S320, the processor 30 may project points acquired by the LiDAR sensor 12 onto an image. The process of projecting the points onto the image may include transforming the coordinates of the points into the coordinates on the pixel coordinate system of the image and displaying the points in an image represented in the pixel coordinate system.

The points may be expressed in the world coordinate system, and a method for transforming the world coordinate system to the pixel coordinate system is described with reference to FIG. 5.

As shown in FIG. 5, the world coordinate system may be used to represent the position of an object in a three-dimensional space. In FIG. 5, point P may represent a certain point on an object.

The position of the object may be determined based on distances from the origin (P0_w) to the Xw-axis, Yw-axis, and Zw-axis. The origin (P0_w) of the world coordinate system may be set to be identical to the origin (P0_c) of the camera coordinate system.

The camera coordinate system may be a three-dimensional coordinate system with the center of a camera lens set as the origin (P0_c). The +Zc axis of the camera coordinate system may indicate the front direction of the camera 11 in which an object is located, the +Yc axis may indicate the downward direction of the camera 11, and the +Xc axis may indicate the rightward direction of the camera 11.

The pixel coordinate system may be used to determine the position of an object on an image captured by the camera 11. The origin of the pixel coordinate system (P0_c) may be the top-left corner of the image, with the Xp-axis potentially pointing to the right and the Yp-axis potentially pointing downward.

A normalized coordinate system may refer to a coordinate system in which the effects of internal parameters of the camera 11 are removed from the pixel coordinate system.

The points may be expressed based on the world coordinate system, and a calibration process may be performed to transform the world coordinate system to the pixel coordinate system. The coordinate transformation may be performed using a rotation matrix and a transformation matrix, and the calibration process may include obtaining the rotation matrix and the transformation matrix.

The processor 30 may express the points acquired by the LiDAR sensor 12 in the pixel coordinate system using the rotation matrix and the transformation matrix.

In S330, the processor 30 may cluster the points based on the depth values of the points to generate one or more 3D bounding boxes.

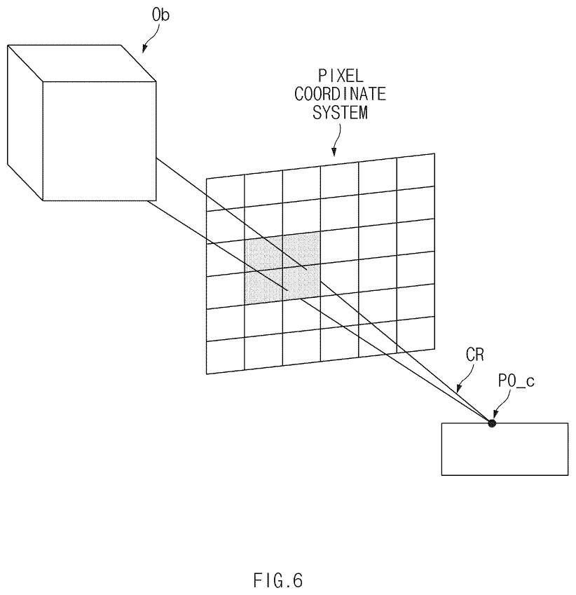

The process for clustering points to generate 3D bounding boxes is described below with reference to FIGS. 6-8.

To cluster the points, the processor 30 may project rays of the camera 11 onto an image.

FIG. 6 is a diagram illustrating a camera ray.

Referring to FIG. 6, a camera ray may refer to light irradiated by the camera 11, and may be a straight line oriented in the Zc-axis direction from the origin P0_c of the camera coordinate system. In other words, any position in the camera ray may include depth value information in the Zc-axis direction from the camera 11.

A method for clustering points that match the camera ray is described below.

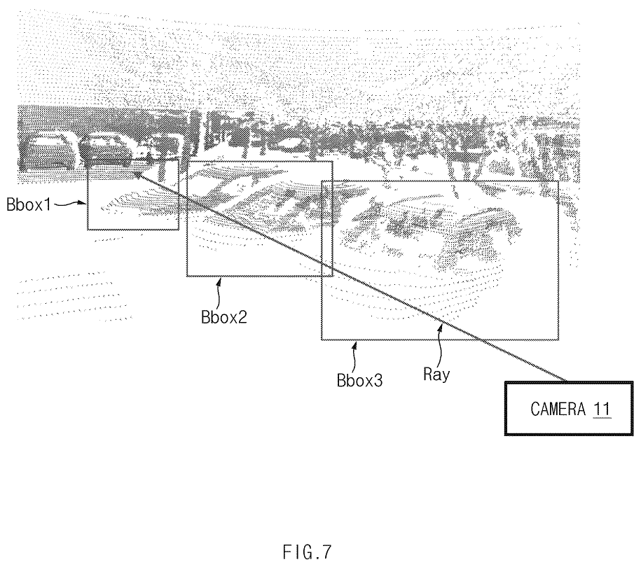

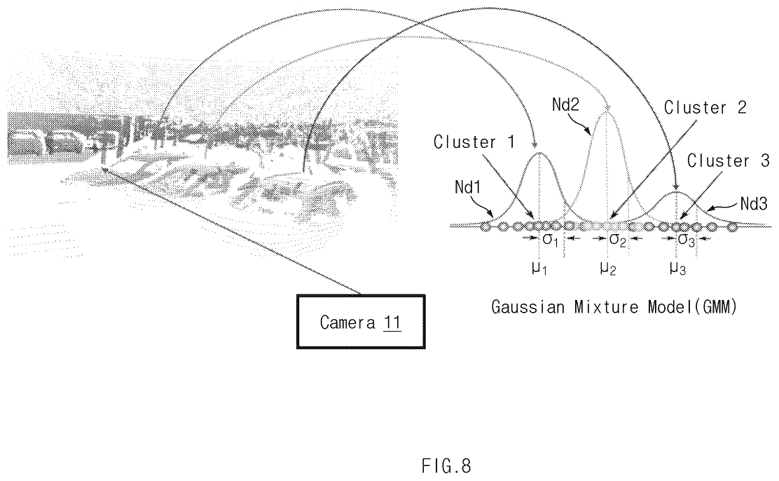

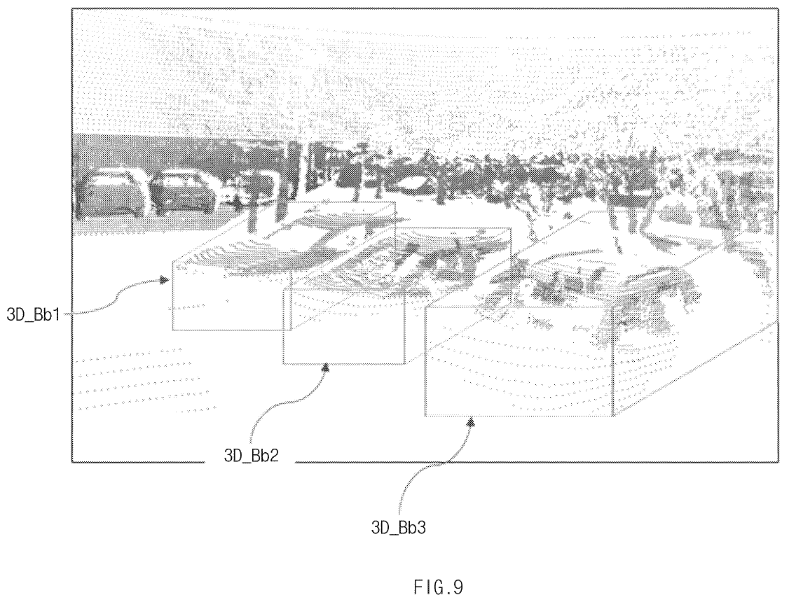

FIG. 7 is a diagram for describing a method for setting up a camera ray. FIG. 8 is a diagram for describing clustering of points matched to a camera ray. FIG. 9 is a diagram illustrating an embodiment in which 3D bounding boxes are generated.

The projection of a camera ray onto an image onto which points are projected may be expressed as a two-dimensional straight line as shown in FIG. 7. In other words, the camera ray shown in FIG. 7 may be the camera ray projected onto the pixel coordinate system, the camera ray being expressed in a three-dimensional space of the world coordinate system shown in FIG. 6.

Further, according to an embodiment, the camera ray may be set or configured to pass through two or more of the 2D bounding boxes Bbox1, Bbox2, and Bbox3.

The processor 30 may then cluster the points that are matched to the camera ray using a Gaussian Mixture Model (GMM).

Among the points that are matched to the camera ray, the positional relationships of points that fall within the 2D bounding boxes Bbox1, Bbox2, and Bbox3 may be represented as separate normal distributions. Therefore, as shown in FIG. 8, the processor 30 may utilize a Gaussian mixture model after setting the number of 2D bounding boxes Bbox1, Bbox2, and Bbox3 to the number of clusters. For example, when the 2D bounding boxes Bbox1, Bbox2, and Bbox3 are three, the Gaussian mixture model may perform operation to distinguish between first to third clusters Cluster1, Cluster2, and Cluster3.

The Gaussian mixture model may calculate the likelihood that the points on the camera ray are generated from each of the first to third normal distributions Nd1, Nd2, and Nd3. The Gaussian mixture model may perform clustering by assigning points to the normal distribution with the highest likelihood.

Furthermore, the parameters of the Gaussian mixture model may be determined based on an Expectation-Maximization algorithm.

The expectation process may include calculating the likelihood that points belong to the first to third clusters Cluster1, Cluster2, and Cluster3 with the mode parameters initialized.

The maximization process may include a process of determining parameters that maximize the probability function by substituting the likelihood value into the probability function. The parameters of the probability function may include a mixture coefficient, a mean, and a variance, and the maximization process may refer to determining the mixture coefficient, mean, and variance.

In the Gaussian mixture model, the initial value of the variance may be set in advance. For example, the initial value of the variance may be predetermined based on the size values of objects. To this end, the size information corresponding to the class information of the objects may be stored in advance. When the class information of the third 2D bounding box Bbox3 corresponding to the third cluster Cluster3 is “van”, the processor 30 may search for the size information corresponding to the van, and determine the initial value of the variance based on the size information.

The processor 30 may cluster the points based on the Gaussian mixture model and generate 3D bounding boxes 3D_Bb1, 3D_Bb2, and 3D_Bb3 to classify the clusters, as shown in FIG. 9.

The processor 30 may match additional information to each of the 3D bounding boxes 3D_Bb1, 3D_Bb2, and 3D_Bb3.

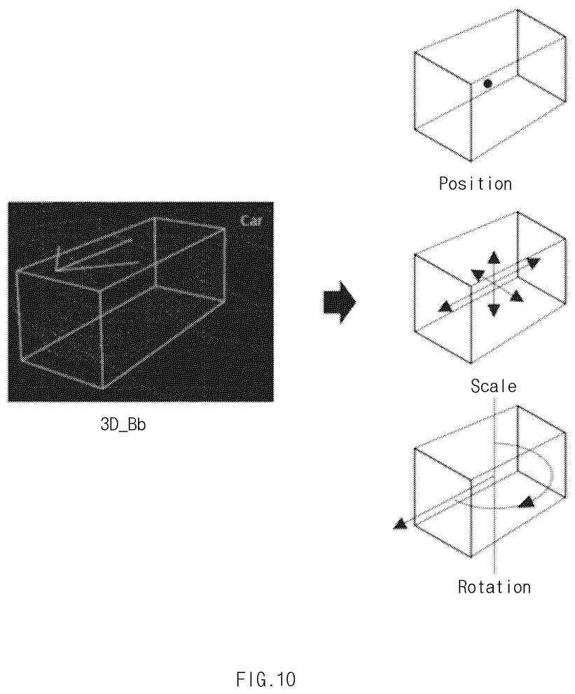

FIG. 10 is a diagram for describing additional information being matched to 3D bounding boxes.

Referring to FIG. 10, the additional information may include class information, coordinate information, and heading information.

The class information may be for identifying a type of an object, and may be identical to class information matched to a 2D bounding box. For example, class information such as Car may be matched.

The position information may be the coordinates of the center point of a 3D bounding box 3D_Bb.

The scale information may include a distance in the three axis directions from the center point of the 3D bounding box 3D_Bb.

The rotation information may include information indicating the heading direction of an object from a rotation axis perpendicular to the center point of the 3D bounding box 3D_Bb.

According to an embodiment, the processor 30 may determine the final position of the 3D bounding box 3D_Bb based on the number of points contained within the 3D bounding box 3D_Bb. For example, the processor 30 may initially generate the 3D bounding box 3D_Bb by clustering points based on a Gaussian mixture model, and move the position of the initially generated 3D bounding box 3D_Bb within a certain range.

As the processor 30 moves the position of the 3D bounding box 3D_Bb, the processor 30 may determine the number of points included within the 3D bounding box 3D_Bb. Furthermore, the processor 30 may determine the position with the largest number of points included within the 3D bounding box 3D_Bb as the final position of the 3D bounding box.

Further, a method of labeling 3D data according to an embodiment of the present disclosure may include a process for filtering 2D bounding boxes.

The 2D bounding boxes Bbox1, Bbox2, and Bbox3 acquired through S310 of FIG. 3 may include results with low confidence scores in object detection. Referring to FIG. 4, a process for filtering 2D bounding boxes output by an object classification network is described below.

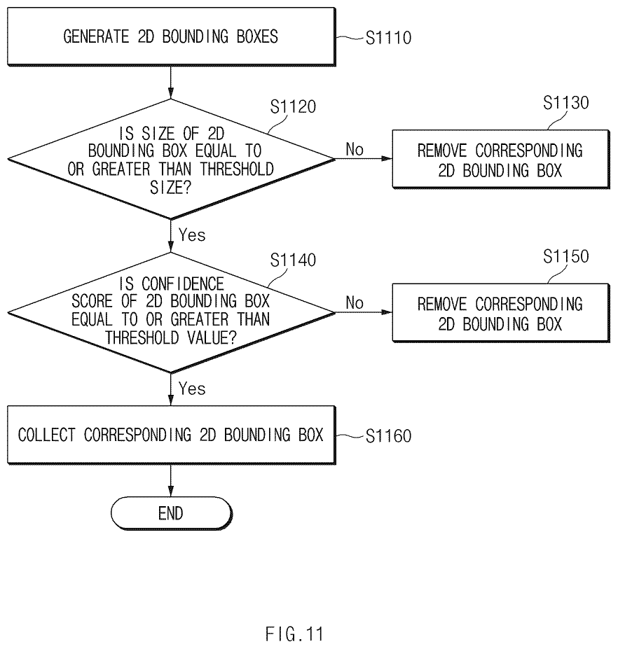

FIG. 11 is a flowchart for describing a method for filtering 2D bounding boxes output by an object classification network.

In S1110, the processor 30 may detect an object in image data and generate a bounding box indicating the position of the detected object.

In S1120, the processor 30 may determine the sizes of the 2D bounding boxes, and compare the sizes of the 2D bounding boxes to a threshold size.

In S1130, when the size of the 2D bounding box is less than the threshold size, the processor 30 may remove the corresponding 2D bounding box.

The size of the 2D bounding box may be generated to become smaller as the size of the object decreases. The processor 30 may remove 2D bounding boxes corresponding to objects detected in the image that are small in size.

Further, the size of the 2D bounding box may decrease as the distance of an object from the camera 11 increases. Among the objects detected in the image, objects located more than a certain distance from the camera 11 may not be accurately classified by deep learning. Therefore, the processor 30 may remove small 2D bounding boxes to remove objects located at a far distance.

In S1140, when the size of a 2D bounding box is greater than or equal to a threshold size, the processor 30 may determine a confidence score of the 2D bounding box and compare the confidence score to a threshold value.

The confidence score may be an index indicative of the accuracy with which the object classification network classified an object.

In S1150, the processor 30 may remove 2D bounding boxes whose confidence scores are less than or equal to the threshold value.

In S1160, the processor 30 may collect the 2D bounding boxes with confidence scores greater than the threshold value. The 2D bounding boxes collected in S1160 may be utilized in a process in which the points acquired by the LiDAR sensor 12 are fused with the 2D bounding boxes.

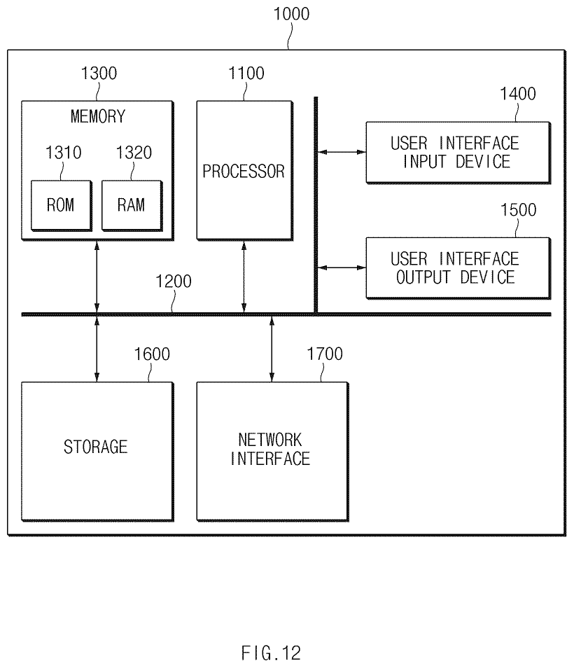

FIG. 12 illustrates a computing system according to an embodiment of the present disclosure.

Referring to FIG. 12, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (e.g., the memory 1300 and/or the storage 1600) such as a RAM, a flash memory, a ROM, an EPROM, an EEPROM, a register, a hard disk, a removable disk, and a CD-ROM.

The storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those of ordinary skill in the art to which the present disclosure pertains.

Accordingly, the embodiments disclosed in the present disclosure are not intended to limit the technical idea of the present disclosure but to describe the present disclosure. The scope of the technical ideas of the present disclosure is not limited by the embodiments described herein. The scope of protection of the present disclosure should be interpreted by the following claims, and all technical ideas within the scope equivalent thereto should be construed as being included in the scope of the present disclosure.

According to the embodiments of the present disclosure, a pseudo-label containing a 3D bounding box generated by fusing a 2D image and points having 3D information is generated and therefore, an operator may perform labeling while referring to the pseudo-label. Accordingly, the time required for manual labeling processes may be significantly reduced.

Further, according to the embodiments of the present disclosure, points are classified based on the depth values of the 3D points projected onto the image, which may address the limitation that points projected onto a 2D image are difficult for humans to classify accurately.

In addition, various effects may be provided that are directly or indirectly understood through the disclosure.

Hereinabove, although the present disclosure has been described with reference to several embodiments and the accompanying drawings, the present disclosure is not limited thereto, but may be variously modified and altered by those of ordinary skill in the art to which the present disclosure pertains without departing from the spirit and scope of the present disclosure claimed in the following claims.

What is claimed is:

1. A pseudo-label generation device comprising:
a camera configured to acquire an image;
a LiDAR sensor configured to acquire points including three-dimensional information; and
a processor configured to:
perform labeling based on the image and the points;
generate two-dimensional (2D) bounding boxes for classifying objects by performing deep learning on the image;
project the points onto the image; and
cluster the points based on depth values of the points to generate three-dimensional (3D) bounding boxes.

2. The pseudo-label generation device of claim 1, wherein the processor is configured to:
determine a size of each of the 2D bounding boxes; and
remove a 2D bounding box whose size is less than a threshold size from among the 2D bounding boxes.

3. The pseudo-label generation device of claim 1, wherein the processor is configured to:
determine a confidence score of each of the 2D bounding boxes; and
remove a 2D bounding box whose confidence score is less than a threshold value from among the 2D bounding boxes.

4. The pseudo-label generation device of claim 1, wherein the processor is configured to:
project a ray of the camera onto the image; and
cluster the points matched to the ray.

5. The pseudo-label generation device of claim 4, wherein the processor is configured to set the ray to pass through the 2D bounding boxes.

6. The pseudo-label generation device of claim 5, wherein the processor is configured to cluster the points matched to the ray based on a Gaussian mixture model generated by setting a number of the 2D bounding boxes as a number of clusters.

7. The pseudo-label generation device of claim 6, wherein the processor is configured to:
identify a class of the 2D bounding box;
determine a standard size of an object corresponding to the class; and
determine an initial value for a variance of the Gaussian mixture model based on the standard size.

8. The pseudo-label generation device of claim 6, wherein the Gaussian mixture model is configured to determine a mixture coefficient, a mean, and a covariance using an expectation-maximization algorithm.

9. The pseudo-label generation device of claim 1, wherein the processor is configured to:
determine a number of the points included within the 3D bounding box while moving a position of the 3D bounding box within a predetermined range; and
determine a position with a largest number of the points as a final position of the 3D bounding box.

10. The pseudo-label generation device of claim 1, wherein the processor is configured to:
extract class information, coordinate information, and heading information of the object, which correspond to each of the 2D bounding boxes, by performing deep learning on the image; and
match the class information, the coordinate information, and the heading information of the object to the 3D bounding box.

11. A pseudo-label generation method comprising:
generating, by a processor, two-dimensional (2D) bounding boxes for classifying objects by performing deep learning on an image acquired by a camera;
projecting, by the processor, points acquired by a LiDAR sensor onto the image; and
clustering, by the processor, the points based on depth values of the points to generate three-dimensional (3D) bounding boxes.

12. The pseudo-label generation method of claim 11, wherein the generating of the 2D bounding boxes includes:
determining a size of each of the 2D bounding boxes; and
removing a 2D bounding box whose size is less than a threshold size from among the 2D bounding boxes.

13. The pseudo-label generation method of claim 11, wherein the generating of the 2D bounding boxes includes:
determining a confidence score of each of the 2D bounding boxes; and
removing a 2D bounding box whose confidence score is less than a threshold value from among the 2D bounding boxes.

14. The pseudo-label generation method of claim 11, wherein the clustering of the points to generate the 3D bounding boxes includes:
projecting a ray of the camera onto the image; and
clustering the points matched to the ray.

15. The pseudo-label generation method of claim 14, wherein the projecting of the ray of the camera onto the image includes:
setting the ray to pass through the 2D bounding boxes.

16. The pseudo-label generation method of claim 11, wherein the clustering of the points to generate the 3D bounding boxes includes:
projecting a ray of the camera onto the image; and
clustering the points matched to the ray,
wherein the projecting of the ray of the camera onto the image includes setting the ray to pass through the 2D bounding boxes, and
wherein the clustering of the points to generate the 3D bounding boxes includes clustering the 3D points matched to the ray based on a Gaussian mixture model generated by setting a number of the 2D bounding boxes as a number of clusters.

17. The pseudo-label generation method of claim 16, wherein the clustering of the points to generate the 3D bounding boxes includes:
identifying a class of the 2D bounding box;
determining a standard size of an object corresponding to the class; and
determining an initial value for a variance of the Gaussian mixture model based on the standard size.

18. The pseudo-label generation method of claim 16, wherein the Gaussian mixture model is configured to determine a mixture coefficient, a mean, and a covariance using an expectation-maximization algorithm.

19. The pseudo-label generation method of claim 11, further comprising:
determining a number of the points included within the 3D bounding box while moving a position of the 3D bounding box within a predetermined range; and
determining a position with a largest number of the points as a final position of the 3D bounding box.

20. The pseudo-label generation method of claim 11, further comprising:
extracting class information, coordinate information, and heading information of the object, which correspond to each of the 2D bounding boxes, by performing deep learning on the image; and
matching the class information, the coordinate information, and the heading information of the object to the 3D bounding box.
